(19) United States
(12) Patent Application Publication
(10) Pub. No.: US 2008/0192116 A1
(43) Pub. Date: Aug. 14, 2008

(54) Real-Time Objects Tracking and Motion Capture in Sports Events

(75) Inventors: Michael Tamir, Tel Aviv (IL); Gal Oz, Kfar Saba (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: SPORTVU LTD., Holon (IL)

(21) Appl. No.: 11/909,080

(22) PCT Filed: Mar. 29, 2006
(86) PCT No.: PCT/IL2006/000388

§ 371 Date: Sep. 19, 2007

Related U.S. Application Data
(60) Provisional application No. 60/666,468, filed on Mar. 29, 2005.

(51) Int. Cl. H04N 7/18; G06K 9/00

(52) U.S. Cl. 348/157; 382/103; 348/E07.085

(57) ABSTRACT

Non-intrusive peripheral systems and methods to track, identify various acting entities and capture the full motion of these entities in a sports event. The entities preferably include players belonging to teams. The motion capture of more than one player is implemented in real-time with image processing methods. Captured player body organ or joints location data can be used to generate a three-dimensional display of the real sporting event using computer games graphics.

### FIELD OF THE INVENTION

The present invention relates in general to real-time object tracking and motion capture in sports events and in particular to “non-intrusive” methods for tracking, identifying and capturing the motion of athletes and objects like balls and cars using peripheral equipment.

### BACKGROUND OF THE INVENTION

Current sport event object monitoring and motion capture systems use mounted electrical or optical devices in conjunction with arena deployed transceivers for live tracking and identification or image processing based “passive” methods for non-real-time match analysis and delayed replays. The existing tracking systems are used mainly to generate athletes/animals/players performance databases and statistical event data mainly for coaching applications. Exemplary systems and methods are disclosed in U.S. Pat. No. 5,363,897, 5,513,854, 6,124,862 and 6,483,511.

Current motion capture methods use multiple electro-magnetic sensors or optical devices mounted on the actor's joints to measure the three dimensional (3D) location of body organs (also referred to herein as body sections, joints or parts). “Organs” refer to head, torso, limbs and other segmentable body parts. Some organs may include one or more joints. Motion capture methods have in the past been applied to isolated (single) actors viewed by dedicated TV cameras and using pattern recognition algorithms to identify, locate and capture the motion of the body parts.

The main disadvantage of all known systems and methods is that none provide a “non-intrusive” way to track, identify and capture the full motion of athletes, players and other objects on the playing field in real-time. Real-time non-intrusive motion capture (and related data) of multiple entities such as players in sports events does not yet exist. Consequently, to date, such data has not been used in computer games to display the 3D representation of a real game in real time.

There is therefore a need for, and it would be advantageous to have “non-intrusive” peripheral system and methods to track, identify and capture full motion of athletes, players and other objects on the playing field in real-time. It would further be advantageous to have the captured motion and other attributes of the real game be transferable in real time to a computer game, in order to provide much more realistic, higher fidelity computer sports games.

### SUMMARY OF THE INVENTION

The present invention discloses “non-intrusive” peripheral systems and methods to track, identify various acting entities and capture the full motion of these entities (also referred to as “objects”) in a sports event. In the context of the present invention, “entities” refer to any human figure involved in a sports activity (e.g. athletes, players, goal keepers, referees, etc.), motorized objects (cars, motorcycles, etc) and other innate objects (e.g. balls) on the playing field. The present invention further discloses real-time motion capture of more than one player implemented with image processing methods. Inventively and unique to this invention, captured body organs data can be used to generate a 3D display of the real sporting event using computer games graphics.

The real-time tracking and identification of various acting entities and capture of their full motion is achieved using multiple TV cameras (either stationary or pan/tilt/zoom cameras) peripherally deployed in the sports arena. This is done in such a way that any given point on the playing field is covered by at least one camera and a processing unit performing objects segmentation, blob analysis and 3D objects localization and tracking. Algorithms needed to perform these actions are well known and described for example in J. Pers and S. Kovacic, “A system for tracking players in sports games by computer vision”, Electrotechnical Review 67(5): 281-288, 2000, and in a paper by T. Matsuyama and N. Ukita, “Real time multi target tracking by a cooperative distributed vision system”, Dept. of Intelligent Science and Technology, Kyoto University, Japan and references therein.

Although the invention disclosed herein may be applied to a variety of sporting events, in order to ease its understanding it will be described in detail with respect to soccer games.

Most real-time tracking applications require live continuous identification of all players and other objects on the playing field. The continuous identification is achieved either “manually” using player tracking following an initial manual identification (ID) and manual remarking by an operator when a player's ID is lost, or automatically by the use of general game rules and logics, pattern recognition for ball identification and especially—identification of the players jersey (shirt) numbers or other textures appearing on their uniforms. In contrast with prior art, the novel features provided herein regarding object identification include:

(1) In an embodiment in which identification is done manually by an operator, providing an operator with a good quality, high magnification image of a “lost player” to remark the player's identification (ID). The provision is made by a robotic camera that can automatically aim onto the last known location or a predicted location of the lost player. It is assumed that the player could not move too far away from the last location, since the calculation is done in every frame, i.e. in a very short period of time. The robotic camera is operative to zoom in on the player.

(2) In an automatic identification, operator-free embodiment, automatically extracting the ID of the lost player by capturing his jersey number or another pattern on his outfit. This is done through the use of a plurality of robotic cameras that aim onto the last location above. In this case, more than one robotic camera is needed because the number is typically on the back side of the player's shirt. The “locking” on the number, capturing and recognition can be done by well known pattern recognition methods, e.g. the ones described in U.S. Pat. No. 5,353,392 to Luquet and Rebuffet and U.S. Pat. No. 5,264,933 to Rosser et al.

(3) In another automatic identification, operator-free embodiment, assigning an automatic ID by using multiple fixed high resolution cameras (the same cameras used for motion capture) and pattern recognition methods to recognize players' jersey numbers as before.

These features, alone or in combination, appear in different embodiments of the methods disclosed herein.

It is within the scope of the present invention to identify and localize the different body organs of the players in real-time using high resolution imaging and pattern recognition methods. Algorithms for determination of body pose and real time tracking of head, hands and other organs, as well as gestures recognition of an isolated human video image are known, see e.g. C. Wren et al. “Pfinder: real time tracking of the human body”, IEEE Transactions on Pattern Analysis and Machine Intelligence, 19(7):780-785, 1997 and A. Aagarwal and B. Triggs “3D human pose from silhouettes by relevance vector regression”, International Conference on Computer Vision & Pattern Recognition, pages II 882-888, 2004 and references therein. The present invention advantageously discloses algorithms for automatic segmentation of all players on the playing field, followed by pose determination of all segmented players in real time. A smooth dynamic body motion from sequences of multiple two-dimensional (2D) views may then be obtained using known algorithms, see e.g. H. Sidenbladh, M. Black and D. Fleet, “Stochastic tracking of 3D human figures using 2D image motion” in Proc. of the European Conference On Computer Vision, pages 702-718, 2000.

It is also within the scope of the present invention to automatically create a 3D model representing the player's pose and to assign a dynamic behavior to each player based on the 2D location (from a given camera viewpoint) of some of his body organs or based on the 3D location of these organs. The location is calculated by triangulation when the same organ is identified by two overlapping TV cameras.

It is further within the scope of the present invention to use the real-time extracted motion capture data to generate instant 3D graphical replays deliverable to all relevant media (TV, web, cellular devices) where players are replaced by their graphical models to which the real player's pose and dynamic behavior are assigned. In these graphical replays, the 3D location of the capturing virtual camera can be dynamically changed.

The players and ball locations and motion capture data can also be transferred via a telecommunications network such as the Internet (in real-time or as a delayed stream) to users of known sports computer games such as “FIFA 2006” of Electronic Arts (P.O. Box 9025, Redwood City, Calif. 94063), in order to generate in real-time a dynamic 3D graphical representation of the “real” match currently being played, with the computer game's players and stadium models. A main advantage of such a representation over a regular TV broadcast is its being 3D and interactive. The graphical representation of player and ball locations and motion capture data performed in a delayed and non-automatic way (in contrast to the method described herein), is described in patent application WO9846029 by Sharir et al.

Also inventive to the current patent application is the automatic real time representation of a real sports event on a user's computer using graphical and behavioral models of computer games. The user can for example choose his viewpoint and watch the entire match live from the eyes of his favorite player. The present invention also provides a new and novel reality-based computer game genre, letting the users guess the player's continued actions starting with real match scenarios.

It is further within the scope of the present invention to use the player/ball locations data extracted in real-time for a variety of applications as follows:

(1) (Semi-) automatic content based indexing, storage and retrieval of the event video (for example automatic indexing and retrieval of the game's video according to players possessing the ball, etc). The video can be stored in the broadcaster's archive, web server or in the viewer's Personal Video Recorder.

(2) Rigid model 3D or 2D graphical live (or instant replays) representations of plays

(3) Slaving a directional microphone to the automatic tracker to “listen” to a specific athlete (or referee) and generation of an instant “audio replay”.

(4) Slaving a robotic camera onto an identified and tracked player to generate single player video clips.

(5) Generation of a “telestrator clip” with automatic “tied to objects” graphics for the match commentator.

(6) Automatic creation of teams and players performance database for sports computer games developers and for “fantasy games”, to increase game's fidelity through the usage of real data collected in real matches.

According to the present invention there is provided a system for real-time object localization and tracking in a sports event comprising a plurality of fixed cameras positioned at a single location relative to a sports playing field and operative to capture video of the playing field including objects located therein, an image processing unit operative to receive video frames from each camera and to detect and segment at least some of the objects in at least some of the frames using image processing algorithms, thereby providing processed object information; and a central server operative to provide real-time localization and tracking information on the detected objects based on respective processed object information.

In an embodiment, the system further comprises a graphical overlay server coupled to the central server and operative to generate a graphical display of the sports event based on the localization and tracking information.

In an embodiment, the system further comprises a statistics server coupled to the central server and operative to calculate statistical functions related to the event based on the localization and tracking information.

According to the present invention there is provided a system for real-time object localization, tracking and personal identification of players in a sports event comprising a plurality of cameras positioned at multiple locations relative to a sports playing field and operative to capture video of the playing field including objects located therein, an image processing unit operative to receive video frames including some of the objects from at least some of the cameras and to detect and segment the objects using image processing algorithms, thereby providing processed object information, a central server operative to provide real-time localization and tracking information on detected objects based on respective processed object information, and at least one robotic camera capable to pan, tilt and zoom and to provide detailed views of an object of interest.

In some embodiments, the system includes a plurality of robotic cameras, the object of interest is a player having an identifying shirt detail, and the system is operative to automatically identify the player from at least one detailed view that captures and provides the identifying shirt item.

In an embodiment, at least one robotic camera may be slaved onto an identified and tracked player to generate single player video clips.

In an embodiment, the system further comprises a graphical overlay server coupled to the central server and operative to generate a schematic playing field template with icons representing the objects.

In an embodiment, the system further comprises a statistics server coupled to the central server and operative to calculate statistical functions related to the sports event based on the localization and tracking information.

In an embodiment, the system further comprises a first application server operative to provide automatic or semiautomatic content based indexing, storage and retrieval of a video of the sports event.

In an embodiment, the system further comprises a first application server a second application server operative to provide a rigid model two dimensional (2D) or three dimensional (3D) graphical representations of plays in the sports event.

In an embodiment, the system is operative to generate a telestrator clip with automatic tied-to-objects graphics for a match commentator.

In an embodiment, the system is operative to automatically create team and player performance databases for sports computer game developers and for fantasy games, whereby the fidelity of the computer game is increased through the usage of real data collected in real matches.

In an embodiment, the system further comprises a graphical overlay server coupled to the central server and operative to generate a schematic playing field template with icons representing the objects;

In an embodiment, the system further comprises a statistics server coupled to the central server and operative to calculate statistical functions related to the event based on the localization and tracking information.

According to the present invention there is provided a system for automatic objects tracking and motion capture in a sports event comprising a plurality of fixed high resolution video cameras positioned at multiple locations relative to a sports playing field, each camera operative to capture a portion of the playing field including objects located therein, the objects including players, an image processing unit (IPU) operative to provide full motion capture of moving objects based on the video streams and a central server coupled to the video cameras and the IPU and operative to provide localization information on player parts, whereby the system provides real time motion capture of multiple players and other moving objects.

In an embodiment, the IPU includes a player identification capability and the system is further operative to provide individual player identification and tracking.

In an embodiment the system further comprises a three-dimensional (3D) graphics application server operative to generate a three dimensional (3D) graphical representation of the sports event for use in a broadcast event.

According to the present invention there is provided a system for generating a virtual flight clip (VFC) in a sports event comprising a plurality of fixed video cameras positioned at multiple locations relative to a sports playing field, each camera operative to capture a portion of the playing field including objects located therein, the objects including players, a high resolution video recorder coupled to each camera and used for continuously recording respective camera real video frames, and a VFC processor operative to select recorded real frames of various cameras, to create intermediate synthesized frames and to combine the real and synthesized frames into a virtual flight clip of the sports game.

According to the present invention there is provided, in a sports event taking place on a playing field, a method for locating, tracking and assigning objects to respective identity group in real-time comprising the steps of providing a plurality of fixed cameras positioned at a single location relative to the playing field and operative to capture a portion of the playing field and objects located therein, providing an image processing unit operative to receive video frames from each camera and to provide image processed object information, and providing a central server operative to provide real-time localization and tracking information on each detected player based on respective image processed object information.

According to the present invention there is provided, in a sports event taking place on a playing field, a method for locating, tracking and individual identifying objects in real-time comprising the steps of providing a plurality of fixed cameras positioned at multiple locations relative to the playing field and operative to capture a portion of the playing field and objects located therein providing an image processing unit operative to receive video frames from each camera and to provide image processed object information, providing a central server operative to provide real-time localization and tracking information on each identified player based on respective image processed object information, and providing at least one robotic camera capable to pan, tilt and zoom and to provide detailed views of an object of interest.

According to the present invention there is provided, in a sports event taking place on a playing field, a method for real-time motion capture of multiple moving objects comprising the steps of providing a plurality of fixed high resolution video cameras positioned at multiple locations relative to a sports playing field, and using the cameras to capture the full motion of multiple moving objects on the playing field in real-time.

According to the present invention there is provided, method for generating a virtual flight clip (VFC) of a sports game, comprising the steps of: at a high resolution recorder coupled to a plurality of fixed video cameras positioned at multiple locations relative to a sports playing field, each camera operative to capture a portion of the playing field including objects located therein, the objects including players, continuously recording respective real camera video frames, and using a VFC processor coupled to the high resolution recorder to select recorded real frames of various cameras, to create intermediate synthesized frames and to combine the real and synthesized frames into a virtual flight clip.

### BRIEF DESCRIPTION OF THE DRAWINGS

For a better understanding of the present invention and to show more clearly how it could be applied, reference will now be made, by way of example only, to the accompanying drawings in which:

FIG. 1 shows the various entities and objects appearing in an exemplary soccer game;

FIG. 2a shows a general block diagram of a system for real-time object tracking and motion capture in sports events according to the present inventions

FIG. 2b shows a schematic template of the playing field with player icons.

FIG. 3 shows a flow chart of a process to locate and track players in a team and assign each player to a particular team in real-time;

FIG. 4 shows a flow chart of an automatic system setup steps;

FIG. 5a shows a block diagram of objects tracking and motion capture system with a single additional robotic camera used for manual players' identification;

FIG. 5b shows a flow chart of a method for players' identification, using the system of FIG. 5a;

FIG. 6a shows a block diagram of objects tracking and motion capture system including means for automatic players' identification using additional robotic cameras and a dedicated Identification Processing Unit.

FIG. 6b shows a flow chart of a method for individual player identification, using the system of FIG. 6a;

FIG. 7a shows a block diagram of objects tracking and motion capture system including means for automatic players identification using high-resolution fixed cameras only (no robotic cameras);

FIG. 7b shows schematically details of an image Processing and Player Identification Unit used in the system of FIG. 7a;

FIG. 7c shows the process of full motion capture of a player;

FIG. 8 shows an embodiment of a system of the present invention used to generate a “virtual camera flight” type effect;

FIG. 9 shows schematically the generation of a virtual camera flight clip;

FIG. 10 shows a flow chart of a process of virtual camera flight frame synthesizing;

### DETAILED DESCRIPTION OF THE PREFERRED EMBODIMENTS

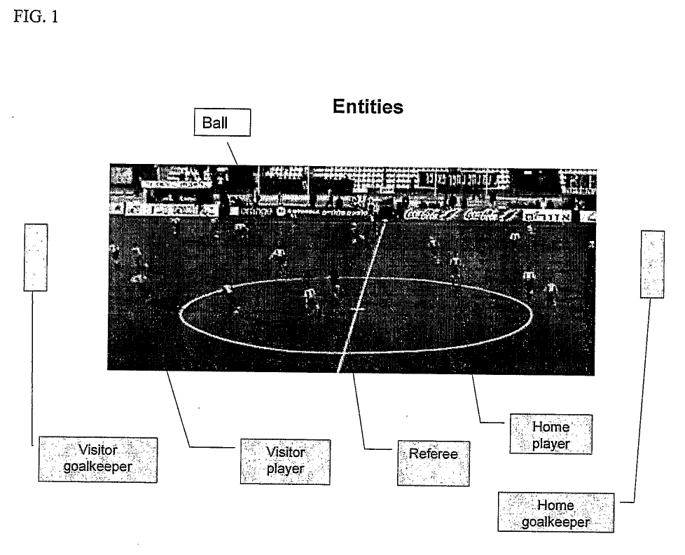

The following description is focused on soccer as an exemplary sports event. FIG. 1 shows various entities (also referred to as “objects”) that appear in an exemplary soccer game: home and visitor (or “first and second” or “A and B”) goalkeepers and players, one or more referees and the ball. The teams are separated and identifiable on the basis of their outfits (also referred to herein as “jerseys” or “shirts”).

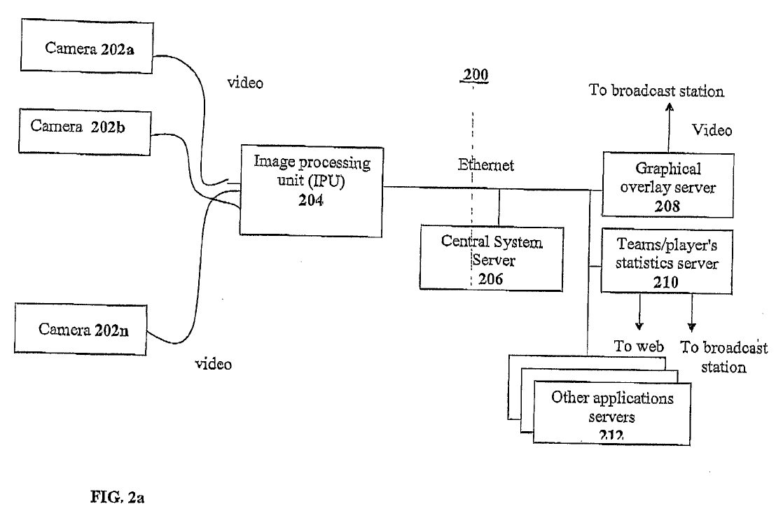

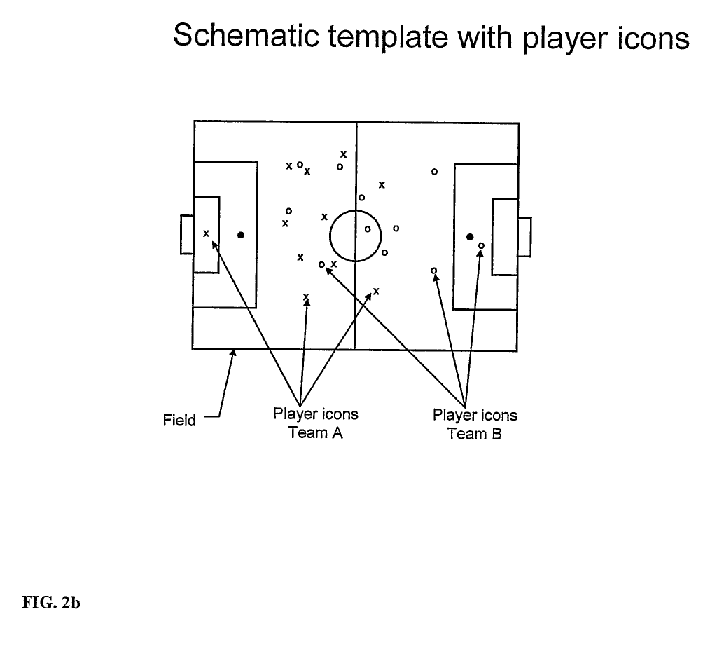

FIG. 2a shows a general block diagram of a system 200 for real-time object tracking and motion capture in sports events according to the present invention. System 200 comprises a plurality of cameras 202a-n (n being any integer greater than 1) arranged in a spatial relationship to a sports playing field (not shown). The cameras are operative to provide video coverage of the entire playing field, each camera further operative to provide a video feed (i.e. a video stream including frames) to an image processing unit (IPU) 204. In some embodiments, IPU 204 may include added functions and may be named image processing and player identification unit (IPPIU). IPU 204 communicates through an Ethernet or similar local area network (LAN) with a central server 206, which is operative to make “system level” decisions where information from more than a single camera is required, like decision on a “lost player”, 3D localization and tracking, object history considerations, etc.; with a graphical overlay server 208 which is operative to generate a graphical display such as a top view of the playing field with player icons (also referred to herein as a “schematic template”); with a team/player statistics server 210 which is operative to calculate team or player statistical functions like speed profiles, or accumulated distances based on object location information; and with a plurality of other applications servers 212 which are operative to perform other applications as listed in the Summary below. For example, a “3D graphics server 212” may be implemented using a DVG (Digital Video Graphics), a PC cluster based rendering hardware with 3Designer, an on-air software module of Orad Hi-Tech Systems of Kfar-Saba, Israel.

An output of graphical overlay server 208 feeds a video signal to at least one broadcast station and is displayed on viewers' TV sets. Outputs of team/player statistics server 210 are fed to a web site or to a broadcast station.

In a first embodiment used for player assignment to teams and generation of a schematic template, cameras 202 are fixed cameras deployed together at a single physical location (“single location deployment”) relative to the sports arena such that together they view the entire arena. Each camera covers one section of the playing field. Each covered section may be defined as the camera's field of view. The fields of view of any two cameras may overlap to some degree. In a second embodiment, the cameras are deployed in at least two different locations (“multiple location deployment”) so that each point in the sports arena is covered by at least one camera from each location. This allows calculation of the 3D locations of objects that are not confined to the flat playing field (like the ball in a soccer match) by means of triangulation. Preferably, in this second embodiment, the players are individually identified by an operator with the aid of an additional remotely controlled pan/tilt/zoom camera (“robotic camera”). The robotic camera is automatically aimed to the predicted location of a player “lost” by the system (i.e. that the system cannot identify any more) and provides a high magnification view of the player to the operator. In a third embodiment, robotic cameras are located in multiple locations (in addition to the fixed cameras that are used for objects tracking and motion capture). The robotic cameras are used to automatically lock on a “lost player”, to zoom in and to provide high magnification views of the player from multiple directions. These views are provided to an additional identification processor (or to an added function in the IPU) that captures and recognizes the player's jersey number (or another pattern on his outfit) from at least one view. In a fourth embodiment, all cameras are fixed high resolution cameras, enabling the automatic real time segmentation and localization of each player's body organs and extraction of a full 3D player motion. Preferably, in this fourth embodiment, the player's identification is performed automatically by means of a “player ID” processor that receives video inputs from all the fixed cameras. Additional robotic cameras are therefore not required. In a fifth embodiment, used for the generation of a “virtual camera flight” (VCF) effect, the outputs of multiple high resolution cameras deployed in multiple locations (typically a single camera in each location) are continuously recorded onto a multi-channel video recorder. A dedicated processor is used to create a virtual camera flight clip and display it as an instant replay.

Player Localization and Tracking Using Cameras Deployed in a Single Location

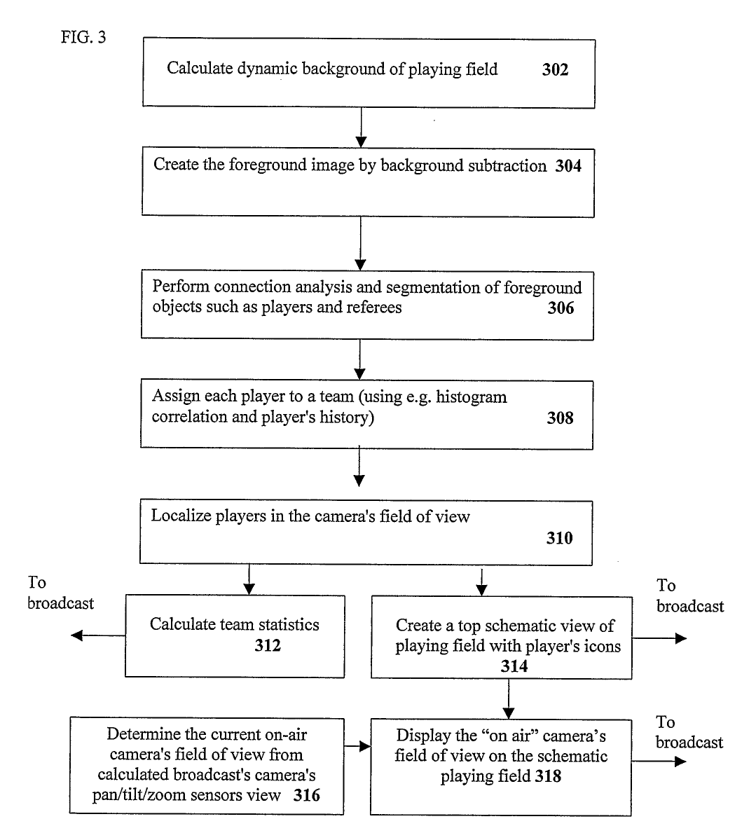

In one embodiment, system 200 is used to locate and track players in a team and assign each object to a particular team in real-time. The assignment is done without using any personal identification (ID). The process follows the steps shown in FIG. 3. The dynamic background of the playing field is calculated by IPU 204 in step 302. The dynamic background image is required in view of frequent lighting changes expected in the sports arena. It is achieved by means of median filter processing (or other appropriate methods) used to avoid the inclusion of moving objects in the background image being generated. The calculated background is subtracted from the video frame by IPU 204 to create a foreground image in step 304. Separation of the required foreground objects (players, ball, referees, etc) from the background scene can be done using a chroma-key method for cases where the playing field has a more or less uniform color (like grass in a typical soccer field), by subtracting a dynamically updated “background image” from the live frame for the case of stationary cameras, or by a combination of both methods. The foreground/background separation step is followed by thresholding, binarization, morphological noise cleaning processes and connection analysis (connecting isolated pixels in the generated foreground image to clusters) to specify “blobs” representing foreground objects. This is performed by IPU 204 in step 306. Each segmented blob is analyzed in step 308 by IPU 204 to assign the respective object to an identity group. Exemplarily, in a soccer match there are 6 identity groups—first team, second team, referees, ball, first goalkeeper, second goalkeeper. The blob analysis is implemented by correlating either the vertical color and/or intensity profiles or just the blob's color content (preferably all attributes) with pre-defined templates representing the various identity teams. Another type of blob analysis is the assignment of a given blob to other blobs in previous frames and to blobs identified in neighboring cameras, using methods like block matching and optical flow. This analysis is especially needed in cases of players' collisions and/or occlusions when a “joint blob” of two or more players needs to be segmented into its “components”, a.k.a. the individual players. The last step in the blob analysis is the determination of the object's location in the camera's field of view. This is done is step 310.

Once the assignment stage is finished, system 200 can perform additional tasks. Exemplarily, team statistics (e.g. team players' average speed, the distance accumulated by all players from the beginning of the match, and field coverage maps) may be calculated from all players' locations data provided by the IPU in step 312. The team statistics are calculated after assigning first the players to respective teams. The schematic template (shown in FIG. 2b) may be created from the localization/teams assignment data inputs by the graphical overlay server 208 in step 314.

Another task that may be performed by system 200 includes displaying the current “on-air” broadcast's camera field of view on the schematic template. The process described exemplarily in FIG. 3 continues as follows. Knowledge of the pan, tilt and zoom readings of the current “on air” camera enables the geometric calculation and display (by system server 206 or another processor) of the momentary “on air” camera's field of view on the schematic playing field in step 316. The “on air” broadcast camera's field of view is then displayed on the template in step 318.

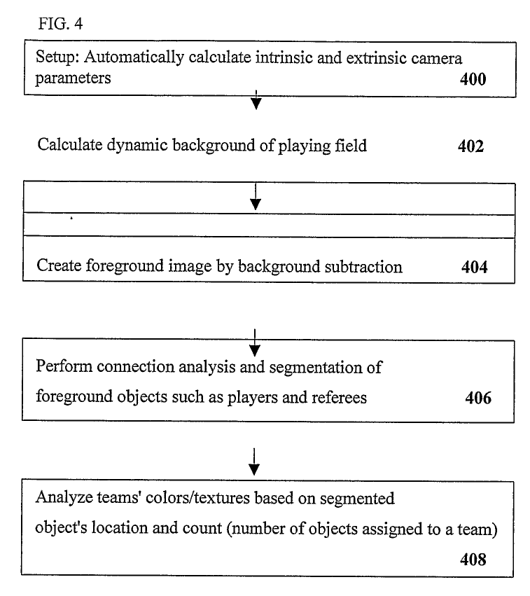

A yet another task that may be performed by system 200 includes an automatic system setup process, as described exemplarily in FIG. 4. System server 206 may automatically learn “who is who” according to game rules, location and number of objects wearing the same outfit, etc. In the game preparation stage, there is no need for an operator to provide the system with any indication of the type “this is goalkeeper A, this is the referee, etc”. The first setup procedure as described in step 400 includes the automatic calculation of the intrinsic (focal length, image center in pixel coordinates, effective pixel size and radial distortion coefficient of the lens) and extrinsic (rotation matrix and translation vector) camera parameters using known software libraries such as Intel's OpenCV package. Steps 402, 404 and 406 are identical with steps 302, 304 and 306 in FIG. 3. In step 408, the team colors and/or uniform textures are analyzed by the IPU based on the locations of each segmented object and their count. For example, the goalkeeper of team 1 is specified by (a) being a single object and (b) a location near goal 1. The color and intensity histograms, as well as their vertical distributions, are then stored into the IPU to be later used for the assignment step of blobs to teams.

Players and Ball Localization, Tracking and Identification Using Cameras Deployed in Multiple Locations

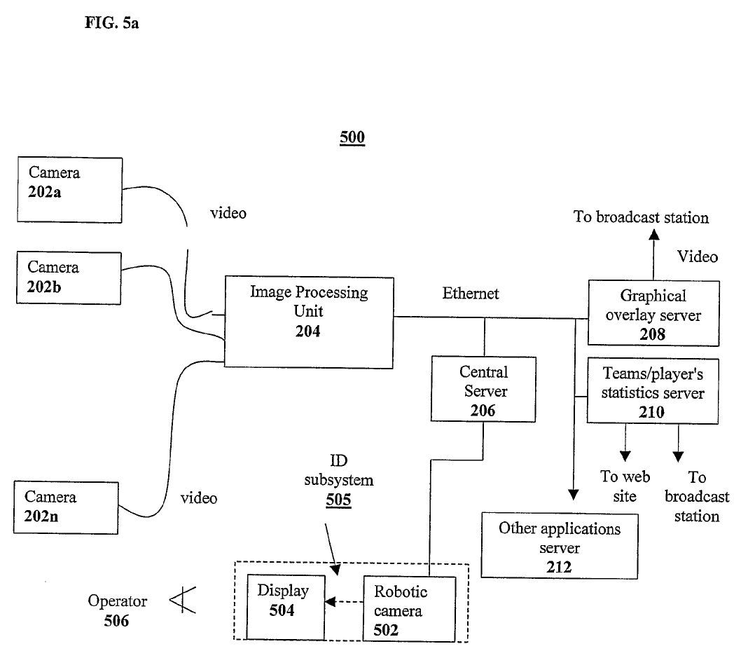

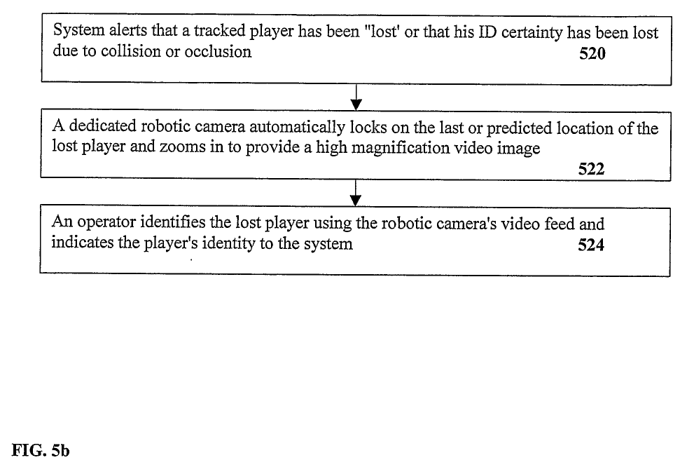

FIG. 5a shows a block diagram of a tracking system 500 in which cameras are deployed in at least two different locations around the sports field in order to detect and localize an object not confined to the flat playing field (e.g. a ball) by means of triangulation (measuring directions from 2 separated locations). System 500 comprises in addition to the elements of system 200 a robotic video camera 502 with a remotely controlled zoom mechanism, the camera mounted on a remotely controlled motorized pan and tilt unit. Such robotic cameras are well known in the art, and manufactured for example by Vinten Inc., 709 Executive Blvd, Valley Cottage, N.Y. 10989, USA. System 500 further comprises a display 504 connected to the robotic camera 502 and viewed by an operator 506. Camera 502 and display 504 form an ID subsystem 505.

The ball is segmented from the other objects on the basis of its size, speed and shape and is then classified as possessed, flying or rolling on the playing field. When possessed by a player, the system is not likely to detect and recognize the ball and it has to guess, based on history, which player now possesses the ball. A rolling ball is situated on the field and its localization may be estimated from a single camera. A flying ball's 3D location may be calculated by triangulating 2 cameras that have detected it in a given frame. The search zone for the ball in a given frame can be determined based on its location in previous frames and ballistic calculations. Preferably, in this embodiment, players are personally identified by an operator to generate an individual player statistical database.

FIG. 5b shows a flow chart of a method for individual player identification implemented by sub-system 505, using a manual ID provided by the operator with the aid of the robotic camera. The tracking system provides an alert that a tracked player is either “lost” (i.e. the player is not detected by any camera) or that his ID certainty is low in step 520. The latter may occur e.g. if the player is detected but his ID is in question due to a collision between two players. The robotic camera automatically locks on the predicted location of this player (i.e. the location where the player was supposed to be based on his motion history) and zooms in to provide a high magnification video stream in step 522. The operator identifies the “lost” player using the robotic camera's video stream (displayed on a monitor) and indicates the player's identity to the system in step 524. As a result, the system now knows the player's ID and can continue the accumulation of personal statistics for this player as well as performance of various related functions.

Note that the system knows a player's location in previous frames, and it is assumed that a player cannot move much during a frame period (or even during a few frame periods). The robotic camera field of view is adapted to this uncertainty, so that the player will always be in its frame.

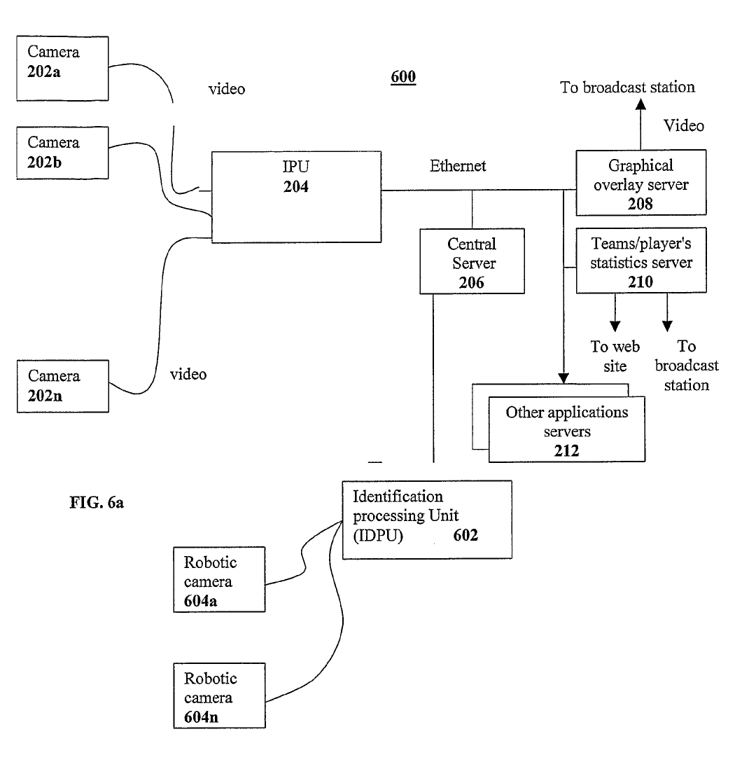

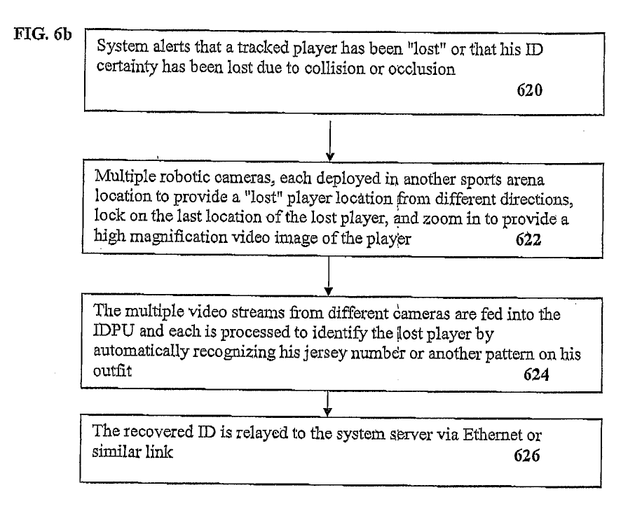

FIG. 6a shows an automatic players/ball tracking and motion capture system 600 based on multiple (typically 2-3) pan/tilt/zoom robotic cameras 604 a . . . n for automatic individual player identification. FIG. 6b shows a flow chart of a method of use. The system in FIG. 6a comprises in addition to the elements of system 200 an Identification Processing Unit (IDPU) 602 connected through a preferably Ethernet connection to system server 206 and operative to receive video streams from multiple robotic cameras 604.

In use, as shown in FIG. 6b, the method starts with step 620, which is essentially identical with step 520 above. Step 622 is similar to step 522, except that multiple robotic cameras (typically 2-3) are used instead of a single one. In step 624, the multiple video streams are fed into IDPU 602 and each stream is processed to identify a player by automatically recognizing his shirt's number or another unique pattern on his outfit. The assumption is that the number or unique pattern is exposed by at least one of the video streams, preferably originating from different viewpoints. The recognized player's ID is then conveyed to the system server (206) in step 626.

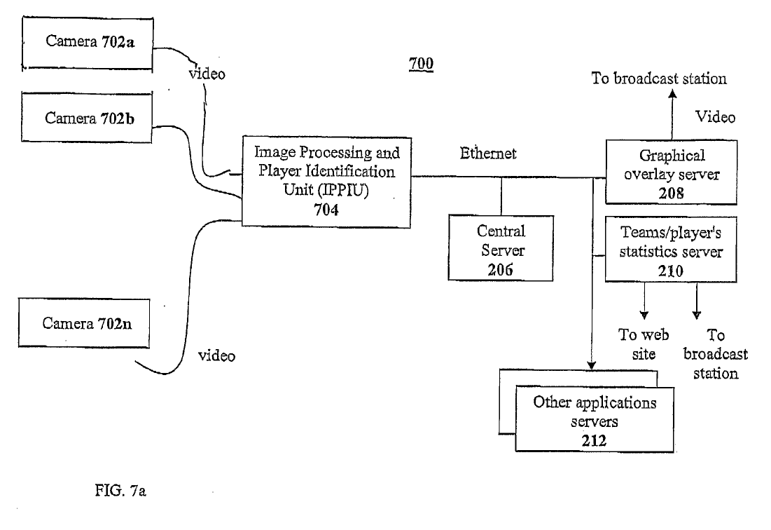

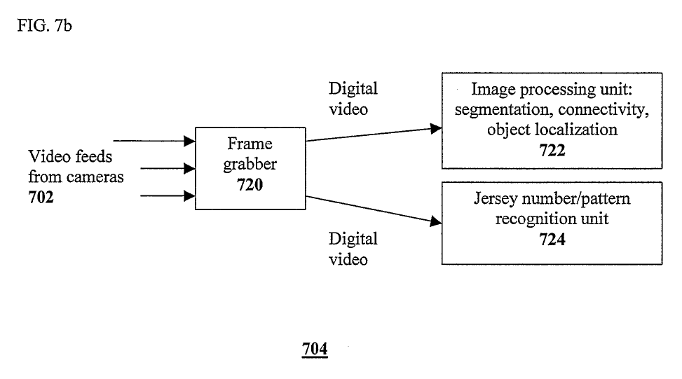

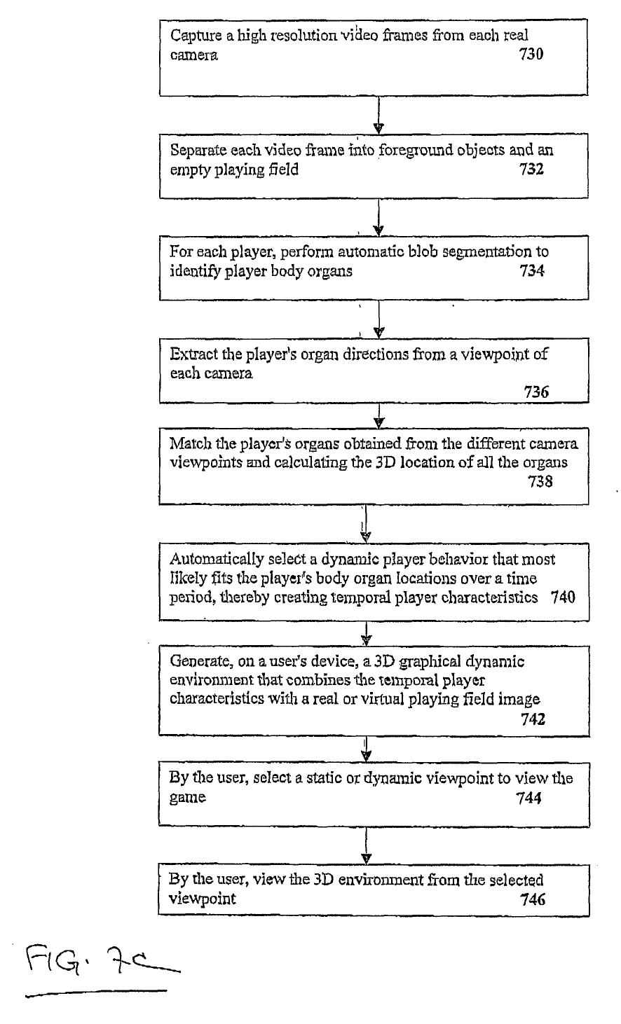

FIG. 7a shows an automatic objects tracking and motion capture system 700 based on multiple high-resolution fixed cameras 702a . . . 702n. System 710 comprises the elements of system 200, except that cameras 702 are coupled to and operative to feed video streams to an image processing and player identification unit (IPPIU) 704, which replaces IPU 204 in FIG. 2a. Alternatively, the added functions of IPPIU 704 may be implemented in IPU 204. FIG. 7b shows schematically details of IPPIU 704. IPPIU 704 comprises a frame grabber 720 coupled to an image processor 722 and to a jersey number/pattern recognition (or simply “recognition”) unit 724. In use, frame grabber 720 receives all the frames in the video streams provided by cameras 702 and provides two digital frame streams, one to unit 722 and another to unit 724. Unit 722 performs the actions of object segmentation, connectivity, blob analysis, etc. and provides object locations on the playing field as described above. Unit 722 may also provide complete motion capture data composed of 3D locations of all players' body parts. Recognition unit 724 uses pattern recognition algorithms to extract and read the player's jersey number or another identifying pattern and provides the player's ID to the system server. This process is feasible when the resolution of cameras 702 is so chosen to enable jersey number/pattern recognition.

In contrast with prior embodiments above, system 700 does not use robotic cameras for player identification. Fixed high resolution cameras 702a . . . 702n are used for both tracking/motion capture and individual players identification

Generation of a 3D Graphical Representation of the Real Match in Real Time in a Computer Game

The information obtained by system 700 may be used for generation of a 3D graphical representation of the real match in real time in a computer game. The resolution of the cameras shown in FIG. 7a can be chosen in such a way to enable a spatial resolution of at least 1 cm on each point on the playing field. Such resolution enables full motion capture of the player as shown in 7c. The high resolution video from each camera is first captured in step 730 by frame grabber 720. The video is then separated into foreground objects and an empty playing field in step 732 as explained in steps 302 and 304 in FIG. 3 by IPPIU 704. Automatic foreground blobs segmentation into player's head, torso, hands and legs is then performed in step 734 by IPPIU 704 using pattern recognition algorithms that are well known in the art (see e.g. J. M. Buades et al, “Face and hands segmentation in color images and initial matching”, Proc. International Workshop on Computer Vision and Image Analysis, Palmas de Gran Canaria, December 2003, pp. 43-48). The player's organs or joints directions from the viewpoint of each camera are extracted in step 736 by IPPIU 704. Specific player's joints or organs detected by different cameras are then matched one to another based on their locations on the playing field and on some kinematic data (general morphological knowledge of the human body) in step 738 by central server 206. A triangulation based calculation of the locations of all body organs of all players is then done in step 738 as well by central server 206.

An automatic selection of a player's dynamic (temporal) behavior that most likely fits his body's joints locations over a time period is then performed in step 740 using least squares or similar techniques by 3D graphics applications server 212. This process can be done locally at the application server 212 side or remotely at the user end. In the latter case, the joints' positions data may be distributed to users using any known communication link, preferably via the World Wide Web.

In step 742, a dynamic graphical environment may be created at the user's computer. This environment is composed of 3D specific player models having temporal behaviors selected in step 740, composed onto a 3D graphical model of the stadium or onto the real playing field separated in step 732. In step 744, the user may select a static or dynamic viewpoint to watch the play. For example, he/she can decide that they want to watch the entire match from the eyes of a particular player. The generated 3D environment is then dynamically rendered in step 746 to display the event from the chosen viewpoint. This process is repeated for every video frame, leading to a generation of a 3D graphical representation of the real match in real time.

Virtual Camera Flight

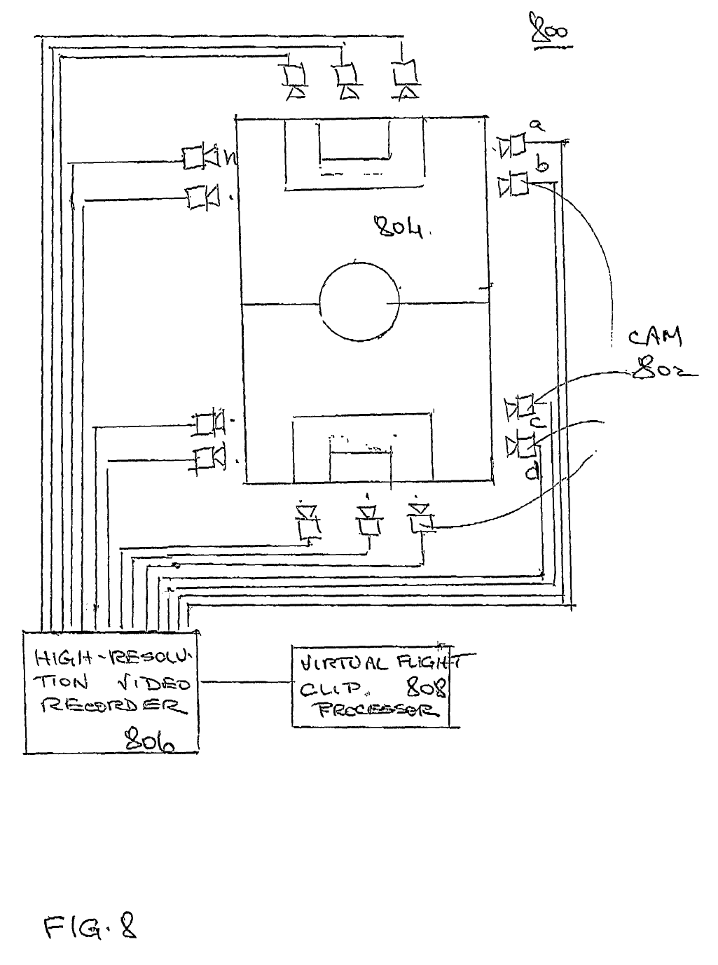

FIG. 8 shows an embodiment of a system 800 of the present invention used to generate a “virtual camera flight”-type effect (very similar to the visual effects shown in the movie “The Matrix”) for a sports event. The effect includes generation of a “virtual flight clip” (VFC). System 800 comprises a plurality of high-resolution fixed cameras 802a-n arranged in groups around a sports arena 804. Each group includes at least one camera. All cameras are connected to a high resolution video recorder 806. The cameras can capture any event in a game on the playing field from multiple directions in a very high spatial resolution (˜1 cm). All video outputs of all the cameras are continuously recorded on recorder 806. A VFC processor 808 is then used to pick selective recorded “real” frames of various cameras, create intermediate synthesized frames, arrange all real and synthesized frames in a correct order and generate the virtual flight clip intended to mimic the effect in “The Matrix” movie as an instant replay in sports events. The new video clip is composed of the real frames taken from the neighboring cameras (either simultaneously, if we “freeze” the action, or at progressing time periods when we let the action move slowly) as well as many synthesized (interpolated) frames inserted between the real ones.

In another embodiment, system 800 may comprise the elements of system 700 plus video recorder 806 and VFC processor 808 and their respective added functionalities

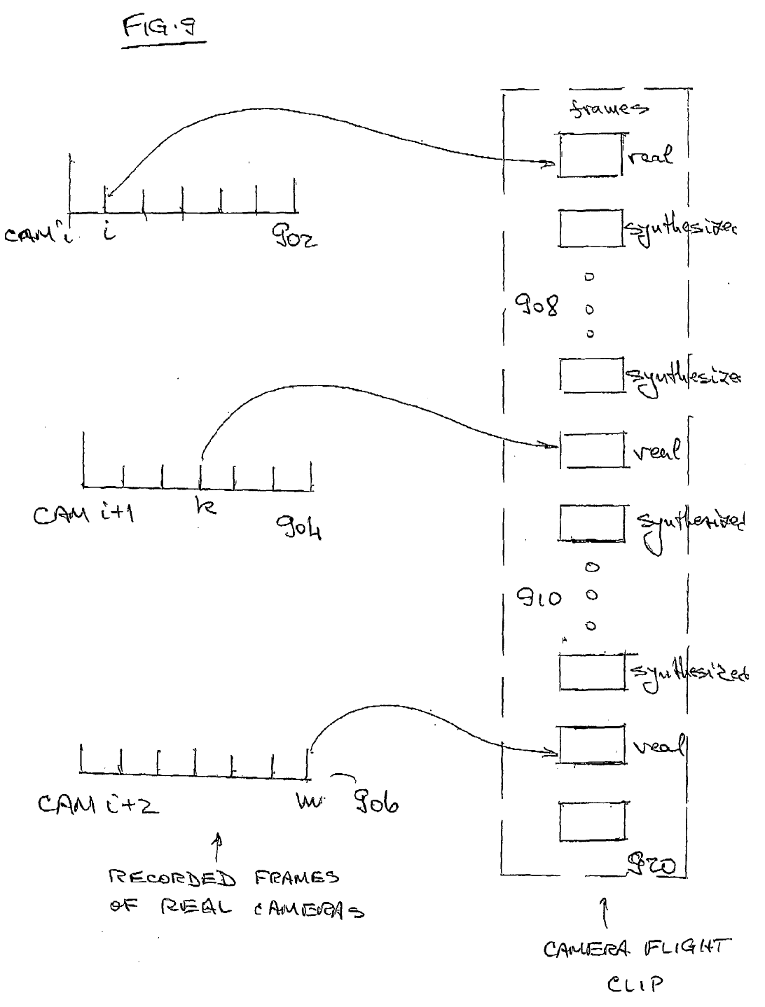

The process is schematically described in FIG. 9. Three symbolic representations of recorded frame sequences of 3 consecutive cameras, CAMᵢ, CAMᵢ₊₁ and CAMᵢ₊₂ are shown as 902, 904 and 906, respectively. The VFC processor first receives a production requirement as to the temporal dynamics with which the play event is to be replayed. The VFC processor then calculates the identity of real frames that should be picked from consecutive real cameras (frames j, k, and m from cameras i, i+1 and i+2 respectively in this example) to create the sequences of intermediate synthesized frames, 908 and 910 respectively, to generate the virtual camera flight clip symbolically represented as 920.

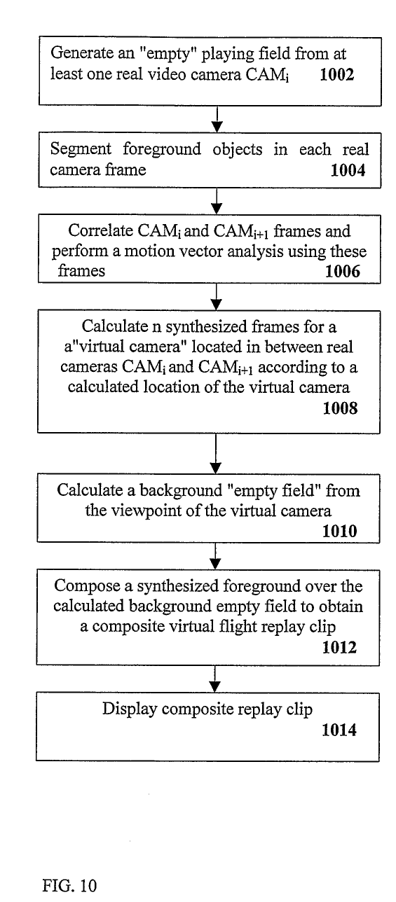

FIG. 10 shows a functional flow chart of the process of FIG. 9. An “empty” playing field is generated as described in step 302 above, using a sequence of video frames from at least one of the cameras in step 1002. Foreground objects are segmented in step 1004. The frames from CAMᵢ and CAMᵢ₊₁ are spatially correlated using known image processing methods like block matching, and a motion vector analysis is performed using optical flow algorithms in step 1006. Both types of algorithms are well known in the art. A virtual camera having the same optical characteristics as the real ones then starts a virtual flight between the locations of real cameras CAMᵢand CAMᵢ₊₁. Both the location of the virtual camera (in the exact video frame timing) and the predicted foreground image for that location are calculated in step 1008 using pixel motion vector analysis and the virtual camera location determined according to the pre-programmed virtual camera flight. The virtual camera background “empty field” is calculated from the same viewpoint in step 1010 and the synthesized foreground and background portions are then composed in step 1012. n such synthesized frames are generated between the real frames of CAMᵢ and CAMᵢ₊₁. The same procedure is now repeated between real CAMᵢ₊₁ and CAMᵢ₊₂ and so on. A video clip composed of such multiple synthesized frames between real ones is generated and displayed to TV viewers in step 1014 as an instant replay showing the play as if it was continuously captured by a flying real camera.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

While the invention has been described with respect to a limited number of embodiments, it will be appreciated that many variations, modifications and other applications of the invention may be made.

1-61. (canceled)

62. A system for real-time object localization and tracking in a sports event comprising:
a. a plurality of fixed cameras positioned at a single location relative to a sports playing field and operative to capture video of the playing field including objects located therein;
b. an image processing unit operative to receive video frames from each camera and to detect and segment at least some of the objects in at least some of the frames using image processing algorithms, thereby providing processed object information; and
c. a central server operative to provide real-time localization and tracking information on the detected objects based on respective processed object information.

63. The system of claim 62, operative to assign each detected object to an object group.

64. The system of claim 63, wherein the detected object is a player, wherein the object group is a team, and wherein the assignment of the player to a team is automatic, without need for an operator to mark the player.

65. The system of claim 63, operative to perform an automatic setup and calibration process, without need for an operator to mark the player during a preparatory stage.

66. A system for real-time object localization, tracking and personal identification of players in a sports event comprising:
a. a plurality of cameras positioned at multiple locations relative to a sports playing field and operative to capture video of the playing field including objects located therein;
b. an image processing unit operative to receive video frames including some of the objects from at least some of the cameras and to detect and segment the objects using image processing algorithms, thereby providing processed object information;
c. a central server operative to provide real-time localization and tracking information on detected objects based on respective processed object information; and
d. at least one robotic camera capable to pan, tilt and zoom and to provide detailed views of an object of interest.

67. The system of claim 66, further comprising a display operative to display the detailed views to an operator.

68. The system of claim 67, wherein the object of interest is a player, and wherein the operator can identify the player from the detailed view.

69. The system of claim 66, wherein one of the objects is a ball, wherein the processed image information includes a location and tracking of the ball provided by the plurality of cameras.

70. The system of claim 68, wherein the player is either not detected or its identity is uncertain and wherein the system is operative to allow the operator to manually remark the lost player.

71. The system of claim 66, wherein the at least one robotic camera includes a plurality of robotic cameras, wherein the object of interest is a player having an identifying shirt detail, and wherein the system is operative to automatically identify the player from at least one detailed view that captures and provides the identifying shirt item.

72. The system of claim 71, wherein the identifying shirt detail is a shirt number.

73. The system of claim 66, wherein at least one robotic camera may be slaved onto an identified and tracked player to generate single player video clips.

74. The system of claim 67, further comprising a first application server coupled to elements b and c and operative to provide automatic or semiautomatic content based indexing, storage and retrieval of a video of the sports event.

75. The system of claim 67, further comprising a second application server coupled to elements b and c and operative to provide a rigid model two dimensional (2D) or three dimensional (3D) graphical representations of plays in the sports event.

76. The system of claim 67, operative to generate a telestrator clip with automatic tied-to-objects graphics for a match commentator.

77. The system of claim 67, operative to automatically create team and player performance databases for sports computer game developers and for fantasy games, whereby the fidelity of the computer game is increased through the usage of real data collected in real matches.

78. A system for automatic objects tracking and motion capture in a sports event comprising:
a. a plurality of fixed high resolution video cameras positioned at multiple locations relative to a sports playing field, each camera operative to capture a portion of the playing field including objects located therein, the objects including players;
b. an image processing unit (IPU) operative to provide full motion capture of moving objects based on the video streams; and
c. a central server coupled to the video cameras and the IPU and operative to provide localization information on player parts,
whereby the system provides real time motion capture of multiple players and other moving objects.

79. The system of claim 78, wherein the IPU includes a player identification capability and wherein the system is further operative to provide individual player identification and tracking.

80. The system of claim 79, wherein the player identification is based on automatically identifying shirt detail

81. The system of claim 78, further comprising a three-dimensional (3D) graphics application server coupled to elements a-c and operative to generate a three dimensional (3D) graphical representation of the sports event for use in a broadcast event.

82. The system of claim 78, further comprising a three-dimensional (3D) graphics application server coupled to elements a-c and used for providing temporal player behavior inputs to a user computer game.

83. A system for generating a virtual flight clip (VFC) in a sports event comprising:
a. a plurality of fixed video cameras positioned at multiple locations relative to a sports playing field, each camera operative to capture a portion of the playing field including objects located therein, the objects including players;
b. a high resolution video recorder coupled to each camera and used for continuously recording respective camera real video frames; and
c. a VFC processor operative to select recorded real frames of various cameras, to create intermediate synthesized frames and to combine the real and synthesized frames into a virtual flight clip of the sports game.

84. In a sports event taking place on a playing field, a method for real-time motion capture of multiple moving objects comprising the steps of:
a. providing a plurality of fixed high resolution video cameras positioned at multiple locations relative to a sports playing field; and
b. using the cameras to capture the full motion of multiple moving objects on the playing field in real-time.

85. The method of claim 84, wherein the objects include players having body organs, and wherein the step of using the cameras to capture the full motion of multiple moving objects includes capturing the full motion of each of multiple players based on image processing of at least some of the body organs of the respective player.

86. The method of claim 85, wherein the capturing of the full motion of each of respective player further includes: using a processing unit:
i. capturing high resolution video frames from each camera,
ii. separating each video frame into foreground objects and an empty playing field,
iii. performing automatic blob segmentation to identify the respective player's body organs, and
iv. extracting the respective player's body organs directions from a viewpoint of each camera,

87. The method of claim 86, wherein the capturing of the full motion further includes:
vi. matching the player's body organs received from the different camera viewpoints, and
vii. calculating a three-dimensional location of all the player's organs including joints.

88. The method of claim 87, wherein the capturing of the full motion further includes automatically selecting a dynamic player's behavior that most likely fits the respective player's body organ location over a time period, thereby creating respective player temporal characteristics.

89. The method of claim 88, further comprising the step of generating, on a user's device, a 3D graphical dynamic environment that combines the temporal player characteristics with a real or virtual playing field image.

90. The method of claim 86, wherein the processing unit is an image processing and player identification unit (IPPIU), the method further comprising the step of using the IPPIU to identify a player from a respective player shirt detail.

91. A method for generating a virtual flight clip (VFC) of a sports game, comprising the steps of:
a. at a high resolution recorder coupled to a plurality of fixed video cameras positioned at multiple locations relative to a sports playing field, each camera operative to capture a portion of the playing field including objects located therein, the objects including players, continuously recording respective real camera video frames; and
b. using a VFC processor coupled to the high resolution recorder to select recorded real frames of various cameras, to create intermediate synthesized frames and to combine the real and synthesized frames into a virtual flight clip.

92. The method of claim 91, wherein the step of using a VFC processor includes:
i. generating an empty playing field from at least one camera CAMᵢ,
ii. segmenting foreground objects in each real camera frame,
iii. correlating real frames of two consecutive cameras CAMᵢ and CAMᵢ₊₁ and performing a motion vector analysis using these frames,
iv. calculating n synthesized frames for a virtual camera located between real cameras CAMᵢ and CAMᵢ₊₁ according to a calculated location of the virtual camera
v. calculating a background empty field from each viewpoint of the virtual camera,
vi. composing a synthesized foreground over the background empty field to obtain a composite replay clip that represents the virtual flight clip, and
vii. displaying the composite replay clip to a user.
